(19) United States
(12) Patent Application Publication
(10) Pub. No.: US 2024/0402388 A1
(43) Pub. Date: Dec. 5, 2024

(54) Method for predicting a surface condition of a road segment

(71) Applicant: Continental Automotive Technologies GmbH, Hannover (DE)

(72) Inventors: Fabien DANIEL, Toulouse (FR); Nicolas BENOIT, Toulouse (FR); Jonathan BONNET, Toulouse (FR)

(73) Assignee: Continental Automotive Technologies GmbH, Hannover (DE)

(21) Appl. No.: 18/699,680

(22) PCT Filed: Oct. 11, 2022
(86) PCT No.: PCT/EP2022/078178

§ 371 Date: Apr. 9, 2024

(30) Foreign Application Priority Data
Oct. 20, 2021 (FR) FR2111152

(51) Int. Cl. G01W 1/10; G06N 20/00

(52) U.S. Cl. CPC G01W 1/10; G06N 20/00

(57) ABSTRACT

A method for predicting a surface condition of a road segment. The method including, for each system in a set of road weather information systems, training a predictive model on the basis of data originating from the system, applying each model trained for a particular system to the data originating from the other systems in the set of systems in order to determine a prediction error, grouping the systems according to a similarity in prediction error, associating a particular context with each group of systems and training a predictive model for each group of systems to which a context was associated. Also disclosed is a device for implementing the prediction method.

### CROSS REFERENCE TO RELATED APPLICATIONS

This application is the U.S. National Phase application of PCT International Application No. PCT/EP2022/078178, filed Oct. 11, 2022, which claims priority to French Patent Application No. FR2111152, filed Oct. 20, 2021, the contents of such applications being incorporated by reference herein.

### FIELD OF THE INVENTION

The invention pertains to the automotive field, and relates particularly to techniques for predicting a weather condition of the surface of a road segment.

### BACKGROUND OF THE INVENTION

Advanced driver-assistance and autonomous driving systems are nowadays undergoing intensive development. In order to travel in maximum safety, it is particularly important for vehicles equipped with such systems to have knowledge of the surface conditions of the roadway on which they are traveling in order to adapt their speed and their safety distances, and to estimate braking distances.

With this aim, models which make it possible to predict the state of the roadway on the basis of atmospheric weather observations and/or forecasts have been developed. Such models are, for example, trained on the basis of weather observations and ground observations so as to establish correlations between atmospheric conditions and the state of the roadway. The temperature or the drying time of a road surfacing may thus, for example, be determined on the basis of an atmospheric temperature, a wind speed, cloud cover and a type of traffic lane.

Road weather information systems (RWISs) distributed over the road network in order to obtain accurate observations on the state of the roadway at various points in the network are also used. These ground observations make it possible to improve the quality of the predictions made by the models for the road segments provided with such systems.

Unfortunately these predictions remain imperfect, notably because not all road segments are equipped with systems, but also because the models do not take account of the local peculiarities of a road segment. For example, the presence of buildings or vegetation casting shadows on the roadway, the presence of a watercourse nearby or indeed topography are so many factors which influence the surface conditions of a road segment. As this context information is not always available, the result is imperfect predictions which may prove to be dangerous for motorists.

There is thus a need for a technique which makes it possible to determine a surface condition of a particular road segment which is more reliable than the techniques currently on offer.

### SUMMARY OF THE INVENTION

To this end, a method is proposed for predicting a surface condition of a road segment, the method comprising the following steps:
Collecting meteorological observations and surface conditions detected by a first set of road weather information systems,
For each system in the first set of systems:
   Training, on the basis of the data collected for the system under consideration, a predictive model MP1 which is suitable for predicting a surface condition on the basis of atmospheric weather data,
   Determining prediction errors committed by predictive models MP1 trained for the other systems in the first set, when they are applied to the data originating from the system under consideration,
Partitioning the first set of systems into groups of systems determined according to a criterion of similarity in the determined prediction errors,
For each of the determined groups, training a predictive model MP2 on the basis of the data collected by the systems in the first set of systems in order to predict a surface condition on the basis of atmospheric data,
Associating at least one context datum with a predictive model MP2,
Predicting a weather condition at the surface of a particular road segment by applying atmospheric weather data obtained for the location of the segment to a predictive model MP2 selected according to a context datum associated with the road segment.

Thus, the method makes it possible to improve the quality of the predictions by selecting a prediction model which is suitable for the environment of the road segment for which the prediction is made. The systems in a first set are partitioned according to similarities in the prediction errors, so that each partition comprises systems which share a comparable environmental context. Indeed, if at least two models have a similar error profile over a set of systems, it may be presumed that these at least two models originate from systems of which the context is comparable. The method thus makes it possible to train models on systems possessing a specific context in order to obtain specialized predictive models according to the context. These specific models are then labeled on the basis of a predictive model trained on a second set of systems for which a context datum is available. In this way, when a vehicle traveling, for example, close to a watercourse requests a surface condition of the roadway, the model specifically trained for the “watercourse” context is used for the prediction.

An advantage of the prediction method is to make it possible to train specialized predictive models for a particular context on the basis of data for which no context information is available. The cost of developing the training data set is thus reduced and the quality of the predictions is improved.

According to one particular embodiment, the step of predicting a weather condition at the surface of a particular road segment comprises:
Identifying (208), on the basis of a digital map, at least one element of context which is liable to influence the surface weather conditions of the segment,
Selecting a predictive model MP2 according to the identified element of context.

In this way, each request to predict a surface condition transmitted by a vehicle is associated with a particular environmental context which makes it possible to select the most suitable model.

According to one particular embodiment, the method is such that it further comprises a step of training a predictive model MP3 in order to predict at least one context datum relating to the environment of a particular road weather information system on the basis:
Of meteorological observations and surface conditions detected by a second set of road weather information systems, and
Of context data relating to the environment of each system in the second set,

The step of associating at least one context datum with a predictive model MP2 comprising applying the predictive model MP3 to data originating from the systems in the group for which the predictive model MP2 was trained.

Training the model MP3 on the basis of data originating from systems for which context information is available makes it possible to find correlations between atmospheric conditions, surface conditions and a feature of the environment. Applying these models to the data originating from the various groups makes it possible to label each group with one or more context data.

According to one particular embodiment, the step of partitioning into groups of systems comprises steps of:
Storing an error vector associated with a particular system in the first set, comprising representative indicators of the prediction errors committed by the predictive models P1 trained for the other systems in the first set, when they are applied to the data originating from the system under consideration,
Determining groups according to at least one criterion of distance calculated between the error vectors associated with the systems in the first set.

Thus, the prediction errors stored in a vector associated with a system constitute a signature of a particular feature of the system. Grouping according to a criterion of distance makes it possible to define groups of systems sharing the same feature.

According to one particular embodiment, a context datum comprises at least one representative value of a particular feature of the environment in a given location, the feature being selected from among the following elements:
A bridge,
A tunnel,
A forest,
A watercourse,
A building,
A drop,
A type of surfacing of the roadway,
A traffic density.

Such elements have a particular influence on the evolution of the surface conditions of a road segment, such as the drying time or the probability of ice, and may be easily identified on the basis of a map in order to label road segments.

A device for predicting a meteorological condition at the surface of a road segment is also proposed, the device comprising a processor and a memory in which are stored program instructions configured to implement the following steps, when they are executed by the processor:
Collecting meteorological observations and surface conditions detected by a first set of road weather information systems,
For each system in the first set of systems:
   Training, on the basis of the data collected for the system under consideration, a predictive model MP1 which is suitable for predicting a surface condition on the basis of atmospheric weather data,
   Determining prediction errors committed by the predictive models MP1 trained for the other systems in the first set, when they are applied to the data originating from the system under consideration,
Partitioning the first set into groups of systems determined according to a criterion of similarity between the determined prediction errors,
For each of the determined groups, training a predictive model MP2 on the basis of the data collected by the systems in the first group in order to predict a surface condition on the basis of atmospheric data,
Associating at least one context datum with a predictive model MP2, and
Predicting a weather condition at the surface of a particular road segment by applying atmospheric weather data obtained for the location of the segment to a predictive model MP2 selected according to a context datum associated with the road segment.

According to another aspect, the invention relates to a server comprising a prediction device such as described above.

According to yet another aspect, the invention relates to a data medium comprising computer program instructions configured to implement the steps of a prediction method such as described above, when the instructions are executed by a processor.

The data medium may be a non-volatile data medium such as a hard disk, a flash memory or an optical disk, for example.

The data medium may be any entity or device capable of storing instructions. For example, the medium may comprise a storage means, such as a ROM, RAM, PROM, EPROM, a CD-ROM or even a magnetic storage means, for example a hard disk.

On the other hand, the data medium may be a transmissible medium such as an electrical or optical signal, which may be routed via an electrical or optical cable, by radio or by other means.

Alternatively, the data medium may be an integrated circuit into which the program is integrated, the circuit being suitable for executing or for being used in the execution of the method in question.

The various aforementioned embodiments or features may be added, independently of or in combination with one another, to the steps of the prediction method. The servers, devices and data media have at least advantages analogous to those conferred by the method to which they relate.

### BRIEF DESCRIPTION OF THE FIGURES

Other features and advantages of aspects of the invention will become more clearly apparent on reading the following description. This description is purely illustrative and should be read with reference to the appended drawings, in which:

FIG. 1 depicts a map of Germany on which two sets of road weather information systems are depicted, and

FIG. 2 is a flowchart on which the main steps of a prediction method according to one particular embodiment are depicted.

### DETAILED DESCRIPTION OF THE PREFERRED EMBODIMENTS

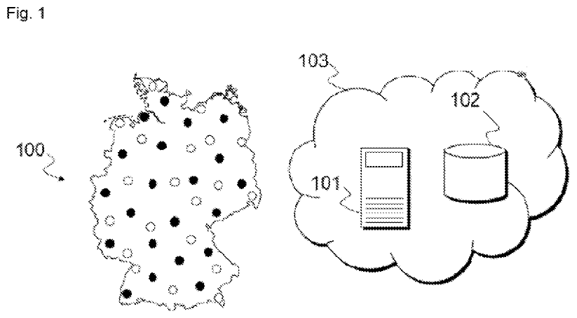

FIG. 1 is a map of Germany 100 on which a first set of road weather information systems is depicted by black dots and a second set of systems is depicted by white dots.

A road weather information system (RWIS) is an automatic weather system comprising sensors and a communication unit which is suitable for transmitting the captured data to a processing center. Such a system makes it possible to obtain data relating to conventional atmospheric weather conditions, but also data relating to the surface conditions of the roadway at the location where it is installed. For this purpose, an RWIS may use an infrared sensor located overhanging the road or a probe implanted in the roadway. These probes only make it possible to probe the conditions of the road very locally, that is to say at a precise point or over a limited surface area for IR probes. Thus, in contrast to atmospheric weather data, which are valid at a larger or smaller scale, the data from an RWIS are highly localized: for example, the shadow cast by a tree may locally affect the temperature by a few degrees, or a dip in the roadway may create a puddle and influence the measurement of a water level. The sensors of such a system make it possible to obtain information relating to the surface temperature of a roadway, wind speed and direction, visibility, the dampness of the roadway and the level of a film of water, the presence of ice or snow, etc.

FIG. 1 also shows a server 101 of a telecommunication network 103 across which the systems depicted on the map may communicate with the server. In particular, the systems depicted on the map may transmit, to the server 101, their observations and measurements via the communication network 103.

The server 101 comprises a communication interface, for example an Ethernet network interface controller, which makes it possible for it to exchange messages with other devices, such as weather information systems. The server 101 also comprises a memory and a processing unit equipped with a processor. The processor of the processing unit is configured, by instructions recorded in the memory, to implement the steps of a prediction method according to one particular embodiment.

The weather information systems of FIG. 1 are thus distributed over various road segments and regularly transmit their observations to the processing server 101 via a network connection, for example via a 3G, 4G or 5G cellular access network or via a wired network.

The server 101 may access a database 102 comprising entries relating to the weather information systems depicted in FIG. 1. These entries comprise data relating to the various weather information systems as well as a history of observations made by each of the systems. The database 102 notably comprises, for each system, a geographic location of the system as well as a history of time-stamped observations made by the system. The database 102 further comprises, for each system in the second set of systems, a context datum relating to a particular feature of the environment of the system, for example a type of surfacing of the road segment monitored by the system, a type of traffic lane, topographical information, such as the presence of a bridge, a building, vegetation, a drop or else a watercourse, etc. More generally, the systems in the second set are particular in that they are associated, in the database 102, with contextual information relating to the immediate environment of a system, such as the presence of elements which are liable to influence the surface weather conditions of the road segment at the location of the system. Indeed, taking account of the sensitivity of the measurements taken by the RWIS probes, an accurate definition of the immediate environment of the observation zone is vital for characterizing the measurement correctly.

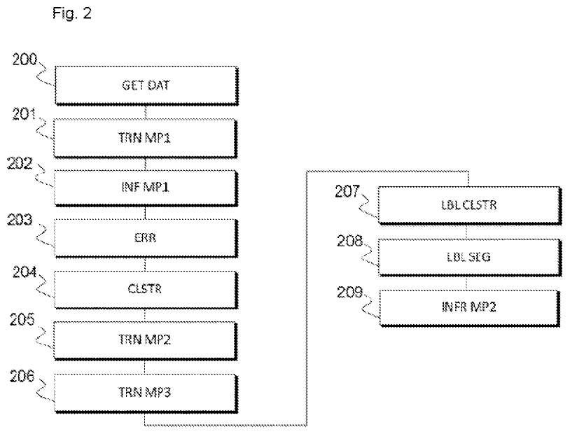

One particular embodiment of the prediction method will now be described with reference to FIG. 2.

During a first step 200, the server 101 collects a history of surface conditions of the roadway which are observed at a plurality of road weather information systems and a history of atmospheric weather forecasts and/or observations corresponding to the zones in which the systems are implanted, and stores these data in a database 102. The server thus has available, for each system and for at least one given period, time-stamped local atmospheric weather observations associated with surface conditions of the road segment monitored by the system. The server also has available, for each system, a location datum, for example geographic coordinates. These coordinates notably make it possible for the server 101 to identify, by matching with a map, the road segment on which a system is installed and to obtain, from a provider of meteorological forecasts, atmospheric weather forecasts for the zone in which a system is implanted.

As has been seen, the entries in the database 102 further comprise, for the second set of systems, contextual information relating to the immediate environment of a system, such as the presence and the orientation of elements which are liable to influence the surface weather conditions of the road segment in proximity to the system. Thus, the systems without associated context data in the database 102 form a first set of systems, and the systems with which a context datum is associated in the database 102 form a second set of systems. It is noted that the majority of the deployed systems do not have associated context data, so that it is difficult to train models for a specific context.

In the step 201, for each system in the first set, a prediction model is trained on the basis of a history of atmospheric weather observations and/or forecasts and observations relating to the state of the roadway in order to predict surface conditions of the roadway on the basis of atmospheric observations. For this purpose, statistical processing is applied to the data in order to obtain characteristic variables. This processing is known by the name “feature engineering”. For example, an average temperature over a particular sliding time window, the cumulative precipitation, a representative value of a UV index, etc. can be calculated. These variables are used to create a feature vector to which the time of day and/or a date may, for example, be added. The feature vector further comprises target variables of the learning model originating from the ground observations made by the system under consideration.

In this way, a first predictive model MP1 which is suitable for predicting a state of the roadway in the vicinity of the system is obtained, for each system in the first set, on the basis of weather forecasts and/or observations for the zone in which the system under consideration is implanted. For example, for each system in the first set, a model may be trained to predict a temperature of the roadway on the basis of weather predictions or observations obtained, for the location of the system, from a provider of weather forecasts or from the system itself. Of course, the models MP1 may be trained to predict other features of the surface, such as its degree of dampness, its “dry”, “icy” or “damp” state or indeed the level of a film of water.

Thus, for each system i in the first set of N systems:

$${WF}_{i} + {GT}_{i} \text{=>} MP {1}_{i}$$

With WFᵢ being the weather data for the location of the system at an instant t, GTᵢ the surface conditions observed by the system i at the instant t and MP1i the model trained for the system i.

During a step 202, each model MP1 trained in the step 201 is used to predict a surface condition at the location of each other system in the first set, the first set comprising N systems. More specifically, each of the models MP1 trained in the step 201 is applied to the weather observations obtained at a particular instant for the other systems in the first set in order to obtain, for each of the N systems in the first set, N−1 surface conditions predicted by various models. A set of temperatures predicted by the models MP1 trained on the basis of the data associated with the other systems is thus obtained, for example, for each system.

The N−1 predictions made for each system in the first set are then compared during a step 203 with the surface conditions observed by the system under consideration in order to determine a prediction error. In other words, the error committed by a model MP1ᵢ associated with a particular system i is calculated in order to predict a surface condition observed by a distinct system. The error may be estimated in different ways and comprise one or more disparity indicators, for example a mean squared error (MSE), a mean absolute error (MAE), an accuracy, a maximum error value, etc. Thus, considering X error indicators, each of the N systems in the first set is associated with a vector comprising N*X values corresponding to the errors in predictions made for the system under consideration and by the other systems. The vector is stored in combination with the system in a memory, for example in the database 102.

In one particular embodiment, the steps 202 and 203 are repeated for a plurality of weather data relating to various periods and/or meteorological conditions. In this way, it is possible to calculate, for example, a mean error committed by a particular model in order to predict a surface condition at the location of another particular system. A plurality of mean errors corresponding to various meteorological conditions may also be calculated. In other words, an error profile is determined which makes it possible to characterize the error of a model when it is applied to the weather data of a region different from the one for which it was trained. The error relates, for example, to a difference in temperature between a temperature predicted by the model and the temperature actually observed, or indeed a disparity between the prediction of a “dry”, “damp”, “icy” or “snowy” surface condition and a condition actually observed or indeed a difference in water level.

In the step 204 the first set of systems is partitioned in order to define groups of systems (“clustered”) according to a criterion of similarity between the error vectors associated with the systems during the step 203. For this purpose, a Euclidean distance between each vector is, for example, calculated and the vectors of which the distance is below a threshold are grouped together. The vectors associated with the various systems constitute a matrix of X*N columns and N rows, with N being the number of systems in the first set and X the number of error indicators, wherein a column i always corresponds to the prediction of the same system and the same indicator. In one particular embodiment, the distance is defined by:

$$\frac{1}{N} * {\sum }_{i = 1}^{N} {( {x}_{i} - {x}_{i}^{′} )}^{2}$$

With xᵢ and x′ᵢ being the component i of two vectors to be compared. It is thus proposed to compare the systems 2 by 2, considering, for each point of comparison, the predictions of a model in a particular metric i, that is to say comparing the corresponding error indicators.

A well-known unsupervised classification algorithm of DBSCAN or kMEANS type is, for example, applied. Such an arrangement makes it possible to obtain groups of models MP1 having similar uncertainties in order to predict a surface condition. As the underlying idea is that, if at least two models have a similar error profile over a set of M systems, it may be presumed that these at least two systems have a comparable context. For example, two models trained on the basis of observations made by a system located in the shadow of a building will have a comparable prediction error when they are applied to data originating from highly exposed systems.

During a step 205, a prediction model MP2 is trained for each group identified in the step 204, aggregating the data from all the systems in the group. For this purpose, a predictive model MP2 for each of the groups of systems determined is trained on the basis of the atmospheric data and corresponding surface conditions observed by the systems. Each model MP2 thus obtained is associated with the group of systems for which it was trained. More generic models, which are less specialized than the models MP1 obtained in the step 201, are thus obtained.

In the step 206, a predictive model MP3 is trained on the basis of the data associated with the systems in the second set for which context information (type of surfacing, type of traffic lane, under a bridge, in the shadow of a building, close to a river, in a forest, etc.) is available. More specifically, the model is trained to predict a particular context on the basis of meteorological observations and surface conditions. The training is carried out on the basis of feature vectors comprising at least variables originating from the atmospheric weather data observed for a system, variables originating from the surface conditions observed by the system, and target variables corresponding to the context data associated with the system.

During the step 207, the model MP3 trained in the step 206 is used to attribute a list of possible contexts to the groups of systems defined for the first set. In this way, each group of systems may be labeled with at least one representative context. The specialization of the model MP2 trained on the basis of the data collected by the systems in a particular group of systems during the step 205 is therefore known. For this purpose, the atmospheric conditions and the surface conditions observed by the groups of systems in the first set are applied to the predictive model MP3 trained in the step 206. As the model MP3 is trained to determine a context on the basis of the atmospheric weather observations and the surface conditions, it is thus possible to associate a context with each group of systems in the first set. As a predictive model MP2 was, in addition, associated with each group of systems during the step 205, an environmental context datum may thus be associated with each of the models MP2.

In the step 208, a digital map of the road network is used to associate a context datum with each road segment. For example, the bridges, the watercourses or the forests referenced on the map are used to associate a context with each road segment.

Finally, during a step 209, a surface condition for a particular road segment is determined by applying one of the models MP2 trained in the step 205 to atmospheric weather observations and/or forecasts obtained for the road segment. The applied model MP2 is selected on the basis of the context associated with the segment in the step 208 and the contexts attributed to the groups in the step 207.

For example, when a vehicle traveling on a particular road segment desires to obtain a surface condition, it transmits, to the server 101, a suitable request comprising its geographic coordinates. On receiving such a message, the server determines, by means of the geographic coordinates, which particular road segment the vehicle is traveling on. In order to identify the road segment, the server matches the received geographic coordinates with a digital representation of the road network. The server 101 then consults the database 102 in order to obtain a context associated with the segment. The server then selects, from among the predictive models MP2 trained in the step 205, a model which is suitable for the context determined for the segment and applies to this model variables originating from atmospheric weather conditions available for the geographic zone in which the road segment is located in order to predict a surface condition. In this way, the vehicle obtains a surface condition which takes account of the peculiarities of the segment on which it is traveling.

According to one particular embodiment, the surface conditions are regularly precalculated by the server 101 for a set of road segments. In this way, on receiving a request originating from a vehicle, the prediction is immediately available.

The models MP1, MP2 and MP3 originate from the family of supervised machine learning models and they are here applied to the particular case of time series. What is meant by “supervised” is that one of the variables of the problem corresponds to the target which it is the aim to predict. Labeling the model ƒ, an input vector x and the target variable y, a problem being dealt with is thus of the type: ƒ′(x)=y. Machine learning models make it possible to obtain an approximation of the real function ƒ which would perfectly describe the evolution of the system, by deriving an approximate function ƒ′ which is obtained by error minimization:

$$ε = g ( {f}^{′} ( x ) - y )$$

where g is an error metric.

In practice, the fact that a time series is being dealt with here implies that there is a strong correlation between 2 observation points y(t₁) and y(t₂) if the observation dates t, and t₂ are close. This strong correlation at the level of the target variables is often present at the level of the input variables x describing the problem. This dependency between the points with respect to time t may be taken into account in several ways during modeling. Some models are intrinsically constructed in order to process time sequences, such as recurrent neural networks (RNNs, LSTMs, etc.) or ARIMA models. Other models may, nevertheless, be used if the input vectors x make it possible to take this time dependency of the observations into account. For example, models which predict the target variables yᵢ independently of one another but create a vector xᵢ associated with this observation, the components of which take the recent observation history into account (for example, via statistics over time windows or gaps between observations in time, etc.), may be used. Conventional machine learning classification or regression models, such as linear or logistic regressions, or more complex models such as decision tree (random forest, or gradient boosting) models, or indeed neural networks, may be thus be used.

1. A method for predicting a meteorological condition at the surface of a road segment, the method comprising:
Collecting meteorological observations and surface conditions detected by a first set of N road weather information systems,
For each system in the first set of systems:
Training, on the basis of the data collected for the system under consideration, a predictive model MP1 which is suitable for predicting a surface condition on the basis of atmospheric weather data,
Applying the model MP1 to data originating from the N−1 other systems in the set,
Determining N−1 prediction errors by comparing the N−1 predictions with corresponding observations originating from the N−1 systems, and
Associating, with the system, an error vector comprising the N−1 determined errors,
Partitioning the first set into groups of systems determined according to a criterion of similarity between the error vectors associated with each system,
For each of the determined groups, training a predictive model MP2 on the basis of the data collected by the systems belonging to the group under consideration in order to predict a surface condition on the basis of atmospheric data,
Associating at least one context datum with a predictive model MP2, and
Predicting a weather condition at the surface of a particular road segment by applying atmospheric weather data obtained for the location of the segment to a predictive model MP2 selected according to a context datum associated with the road segment.

2. The method as claimed in claim 1, wherein the step of predicting a weather condition at the surface of a particular road segment comprises:
Identifying, on the basis of a digital map, at least one element of context which is liable to influence the surface weather conditions of the segment, and
Selecting a predictive model MP2 according to the identified element of context.

3. The method as claimed in claim 1, further comprising a step of training a predictive model MP3 in order to predict at least one context datum relating to the environment of a particular road weather information system on the basis:
Of meteorological observations and surface conditions detected by a second set of road weather information systems, and
Of context data relating to the environment of each system in the second set,
The step of associating at least one context datum with a predictive model MP2 comprising applying the predictive model MP3 to data originating from the systems in the group for which the predictive model MP2 was trained.

4. The method as claimed in claim 1, wherein the step of partitioning into groups of systems comprises steps of:
Storing an error vector associated with a particular system in the first set, comprising representative indicators of the prediction errors committed by the predictive models MP1 trained for the other systems in the first set, when they are applied to the data originating from the system under consideration, and
Determining groups according to at least one criterion of distance calculated between the error vectors associated with the systems in the first set.

5. The method as claimed in claim 1, wherein a context datum comprises at least one representative value of a particular feature of the environment in a given location, selected from among:
A bridge,
A tunnel,
A forest,
A watercourse,
A building,
A drop,
A type of surfacing of the roadway,
A traffic density.

6. A device for predicting a meteorological condition at the surface of a road segment, the device comprising a processor and a memory in which are stored program instructions configured to implement the following steps, when they are executed by the processor:
Collecting meteorological observations and surface conditions detected by a first set of N road weather information systems,
For each system in the first set of systems:
Training, on the basis of the data collected for the system under consideration, a predictive model MP1 which is suitable for predicting a surface condition on the basis of atmospheric weather data,
Applying the model MP1 to data originating from the N−1 other systems in the set,
Determining N−1 prediction errors by comparing the N−1 predictions with corresponding observations originating from the N−1 systems, and
Associating, with the system, an error vector comprising the N−1 determined errors,
Partitioning the first set into groups of systems determined according to a criterion of similarity between the error vectors associated with each system,
For each of the determined groups, training a predictive model MP2 on the basis of the data collected by the systems belonging to the group in order to predict a surface condition on the basis of atmospheric data,
Associating at least one context datum with a predictive model MP2, and
Predicting a weather condition at the surface of a particular road segment by applying atmospheric weather data obtained for the location of the segment to a predictive model MP2 selected according to a context datum associated with the road segment.

7. A server comprising a prediction device as claimed in claim 6.

8. A data medium comprising computer program instructions configured to implement the steps of a prediction method as claimed in claim 1 when the instructions are executed by a processor.
